(19) United States
(12) Patent Application Publication
(10) Pub. No.: US 2015/0112470 A1
(43) Pub. Date: Apr. 23, 2015

(54) COMPUTING DEVICE AND METHOD FOR IMAGE MEASUREMENT

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN)

(21) Appl. No.: 14/516,790

(22) Filed: Oct. 17, 2014

(30) Foreign Application Priority Data
Oct. 17, 2013 (CN) 201310487898.5

(51) Int. Cl. G05B 19/418

(52) U.S. Cl. CPC G05B 19/41875; G05B 2219/37063
USPC 700/109

(57) ABSTRACT

A computing device measures an object using images of the object. The computing device processes the images to obtain a focus of a lens of the CNC machine. A second image of the object is captured at a focus of the lens of the CNC machine. The computing device obtains measurement points according to the second image. The computing device calculates a difference between determined coordinates of each measurement point and reference coordinates of a reference point corresponding to each measurement point.

### CROSS-REFERENCE TO RELATED APPLICATIONS

This application claims priority to Chinese Patent Application No. 201310487898.5 filed on Oct. 17, 2013, the contents of which are incorporated by reference herein.

### FIELD

Embodiments of the present disclosure relate to a simulation technology, and particularly to a computing device and a simulation method for processing an object.

### BACKGROUND

A computerized numerical control (CNC) machine is used to process a component of an object (for example, a shell of a mobile phone), and measure an object to capture images of the object. After the CNC machine has processed the component of the object, the CNC needs to measure the object.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a computing device.

FIG. 2 shows a plan view of an example of a computerized numerical control (CNC) measurement unit of a CNC machine connected to the computing device in FIG. 1.

FIG. 3 shows a diagrammatic view of an example of a line chart generated by pixel gray values of images after binary processing of the images.

FIG. 4 shows a diagrammatic view of an example of measurement points from an image of an object to be tested.

FIG. 5 shows a diagrammatic view of an example of simulating a curve using the measurement points.

FIG. 6 shows a diagrammatic view of an example of establishing a coordinate system according to the curve.

FIG. 7 is a flowchart of an example embodiment of a method for image measurement.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

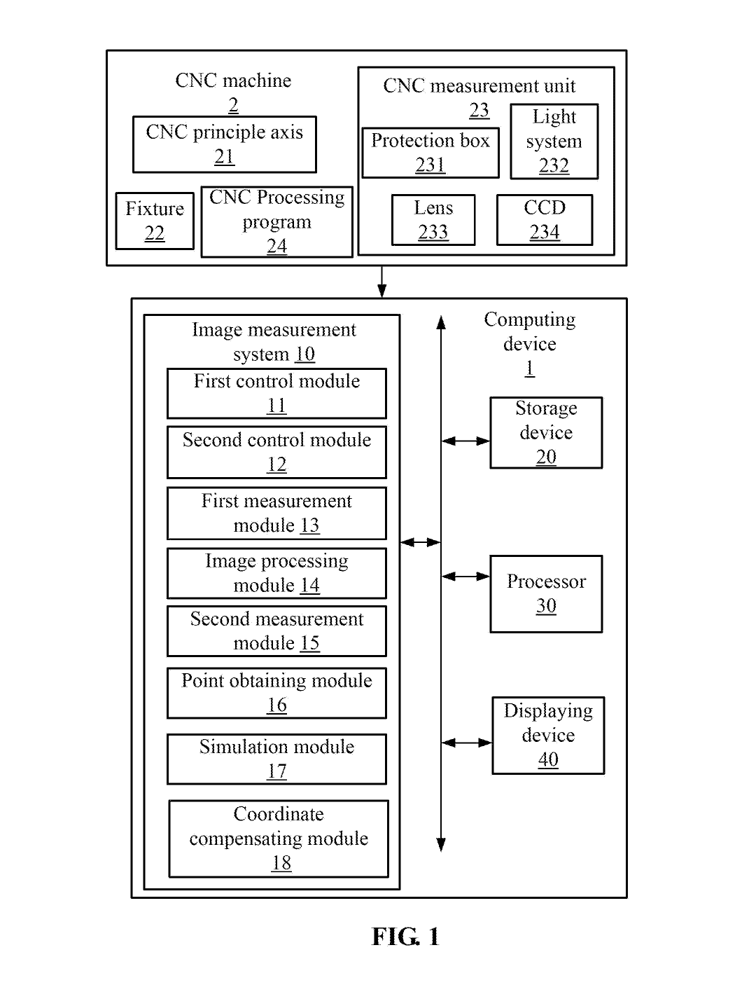

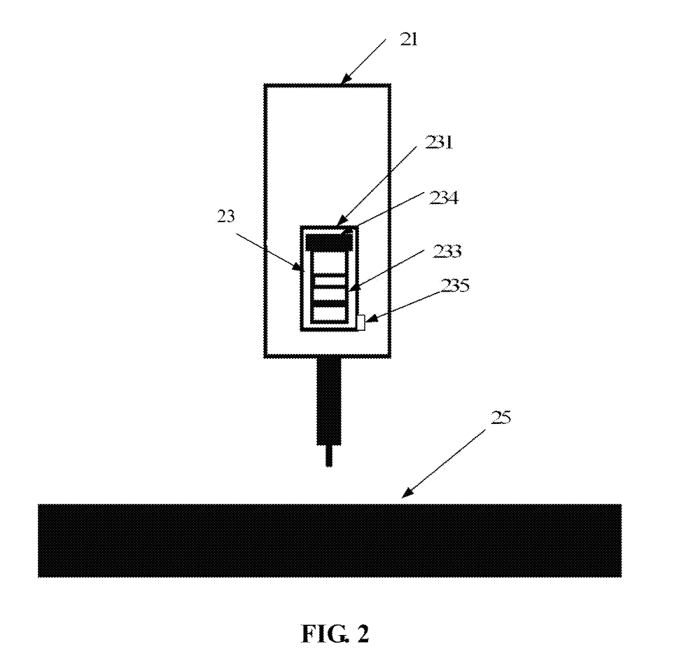

FIG. 1 illustrates a block diagram of an example embodiment of a computing device 1. In at least the embodiment, the computing device 1 provides functions of connections, so that a computerized numerical control (CNC) machine 2 can be connected to the computing device 1. In other embodiments, the computing device 1 can be integrated into the CNC machine 2. That is, the computing device 1 can be a part of the CNC machine 2. The CNC machine 2 can measure an object by capturing images of the object. The object is positioned in a platform 25 (shown in FIG. 2) of the CNC machine 2, and the object 4 is a component of a product, such a shell of an electronic device (for example, a mobile phone).

The computing device 1 can be, but is not limited to, a tablet computer, a server, a personal computer, a mobile phone, or any other computing device. In the example embodiment, the computing device 1 includes, but is not limited to, an image measurement system 10, a storage device 20, at least one processor 30, and a displaying device 40. FIG. 1 illustrates only one example of the computing device 1, and other examples can comprise more or fewer components than those shown in the embodiment, or have a different configuration of the various components.

In at least one embodiment, the storage device 20 can be an internal storage device, such as a flash memory, a random access memory (RAM) for temporary storage of information, and/or a read-only memory (ROM) for permanent storage of information. The storage device 20 can also be an external storage device, such as an external hard disk, a storage card, or a data storage medium. The at least one processor 30 can be a central processing unit (CPU), a microprocessor, or other data processor chip that performs functions of the computing device 1. The storage device 20 stores the images of the object. The displaying device 40 displays the images of the object.

The CNC machine 2 includes a CNC principle axis 21, a fixture 22, a CNC measurement unit 23, and a CNC processing program 24 which is stored in a medium of the CNC machine. The CNC processing program 24 is an array program which consists of a plurality of reference point coordinates. The reference points are predetermined to generate a reference object designed by an application (for example, computer aided design, CAD). In addition, the CNC processing program can be, but is not limited to, a TXT format file.

In at least embodiment, the CNC measurement unit 23 can include a protection box 231, a light system 232, a lens 233, and a charge coupled device (CCD) 234. As shown in FIG. 2, the CNC measurement unit 23 is fixed onto the CNC principle axis 21 by a fixture 22. To ensure an axis of an imaging plane of the CCD 234 is vertical to a processing plane of the CNC machine 2, a perpendicularity error needs to satisfy a predetermined precision requirement, for example, is less than one millimeter (mm). The imaging plane of the CCD 234 can be regarded as a plane which is parallel with the platform 25 of the CNC machine 2. The processing plane of the CNC machine 2 can be regarded as another plane which is parallel with the platform 25 of the CNC machine 2. The lens 233 is located in front of the CCD 234. The lens 233 can be, but is not limited to, a lens including a function of depth of filed. The light system 232 is located at a bottom of the lens 233, includes a light card, a first light source and a second light source. Both the first light source and the second light source can be LED devices. The first light source and the second light source are located at different positions, and provide light to the object in different positions. In addition, when the CNC measurement unit 23 is in an idle mode, the protection box 231 uses a cover to entirely cover the light system 232, the lens 233 and the CCD 234. The CNC measurement unit 23 drives a motor 235 located at the bottom of the protection box 231 to open the cover, when CNC measurement unit 23 is started for measuring the object.

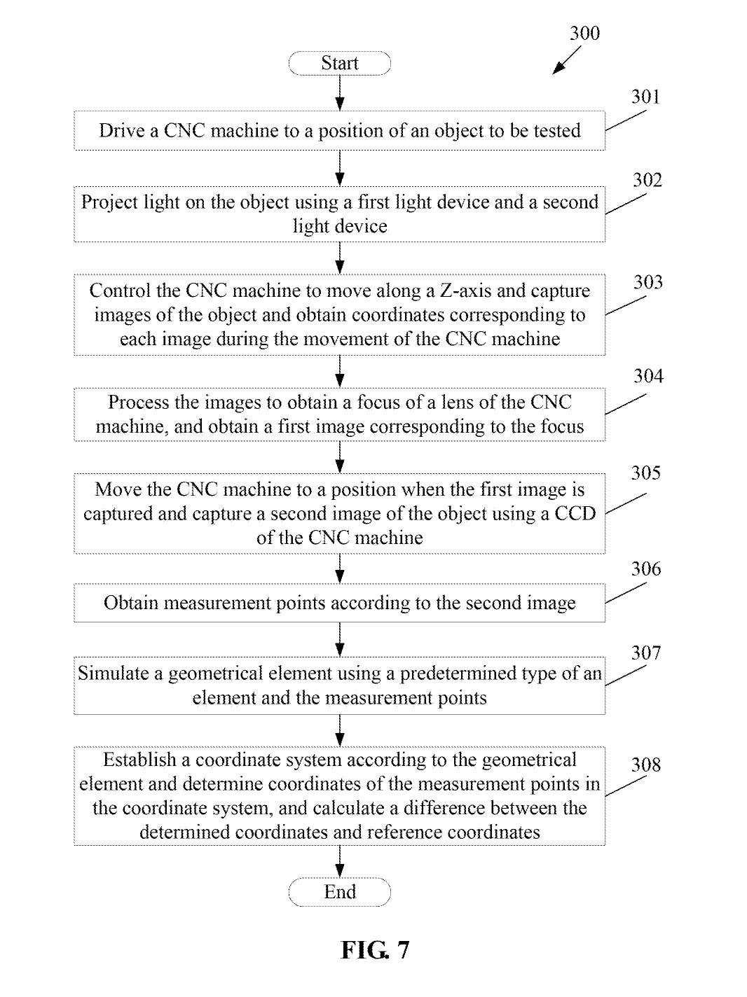

The image measurement system 10 comprises, but is not limited to, a first control module 11, a second control module 12, a first measurement module 13, an image processing module 14, a second measurement module 15, a point obtaining module 16, a simulation module 17, and a coordinate compensating module 18. Modules 11-18 can comprise computerized instructions in the form of one or more computer-readable programs that can be stored in a non-transitory computer-readable medium, for example the storage device 20, and executed by the at least one processor 30 of the computing device 1. A detailed description of the functions of the modules 11-18 is given below in reference to FIG. 7.

FIG. 7 illustrates a flowchart of an example embodiment of a method for image measurement. In an example embodiment, the simulation method is performed by execution of computer-readable software program codes or instructions by at least one processor of a computing device, and can automatically measure images of the object.

Referring to FIG. 7, a flowchart is presented in accordance with an example embodiment. The method 300 is provided by way of example, as there are a variety of ways to carry out the method. The method 300 described below can be carried out using the configurations illustrated in FIGS. 1 and 7, for example, and various elements of these figures are referenced in explaining example method 300. Each block shown in FIG. 7 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The example method 300 can begin at block 301.

In block 301, a first control module 11 starts a CNC machine 2 and drives a motor 235 located at the bottom of a protection box 231 to open a cover of the protection box 231. In at least one embodiment, the cover of the protection box 231 is opened, so that a light system 232, a lens 233 and a CCD 234 are uncovered. That is, the light system 232 can project light on the surface of the object, the lens 233 can capture images of the object and the CCD 234 can generate images of the object.

In block 302, a second control module 12 starts the light system 232 to project light from the first light source and the second light source on the surface of the object.

In block 303, a first measurement module 13 controls the CNC machine 2 to move along a principle axis, and captures images of the object and obtains coordinates corresponding to each image during the movement of the CNC machine 2. The coordinates corresponding to each image are the coordinates of the CCD 234 when the image is captured by the CCD 234. In at least one embodiment, the CCD 234 captures an image every a predetermined time (for example, every one second). The CNC machine 2 includes a grating ruler for obtaining the coordinates of the lens 233 when the lens 233 captures images of the object. In addition, the images of the object and the coordinates corresponding to each image are saved into the storage device 20.

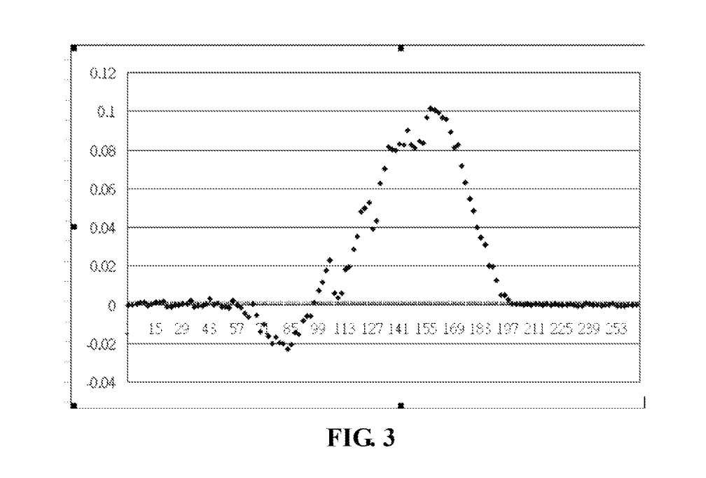

In block 304, an image processing module 14 processes the images to obtain a focus of the lens 233 of the CNC machine 2, and obtains a first image corresponding to the focus. In at least one embodiment, the image processing module 14 processes the images of the object using a binary processing method to generate a pixel gray value of each image. The image processing module 14 further generates a line chart (as shown in FIG. 3) using the pixel gray value of each image. An abscissa of the line chart represents the pixel gray value of the image, and a vertical axis of the line chart represents a Z-axis value of the coordinates of the lens 233 when the image is captured. The focus of the lens 233 is a maximum Z-axis value of the coordinates of the lens 233 among the line chart. The first image corresponding to the focus of the lens 233 is an image which is captured by the lens 233 located at the maximum Z-axis value of the coordinates of the lens 233 among the line chart.

In block 305, a second measurement module 15 controls the CNC machine 2 to move to the focus of the lens 233 and controls the CCD 234 to capture a second image of the object. The image processing module 14 processes the second image using the binary processing method.

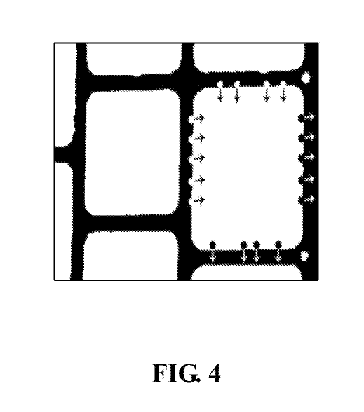

In block 306, a point obtaining module 16 obtains measurement points according to the second image. In at least one embodiment, after the second image is processed by a binary processing method, a contour of the object is generated, as shown in black portion in FIG. 4. In at least one embodiment, if a pixel of the second image exceeds a predetermined pixel gray value (e.g., 155) which is at a range of [0, 255], the pixel of the second image is shown as a black point in the second image. The black points consist of the contour of the object, as shown in FIG. 4. Otherwise, if the pixel of the second image is less than or equal to a predetermined pixel gray value (e.g., 155) which is at the range of [0, 255], the pixel of the second image is shown as a white point in the second image. That is, the contour of the object is shown as the black portion in FIG. 4. In addition, because of the object includes measurement lines predetermined by a user, the measurement lines are arrows on the object indicating a processing position of the object. That is, the second image also includes the measurement lines as shown in FIG. 4, for example. The point obtaining module 16 obtains interchange points where the predetermined measurement lines interchange the contour of the object, as shown in FIG. 4, for example. The measurement points are the interchange points where the predetermined measurement lines interchange the contour of the object.

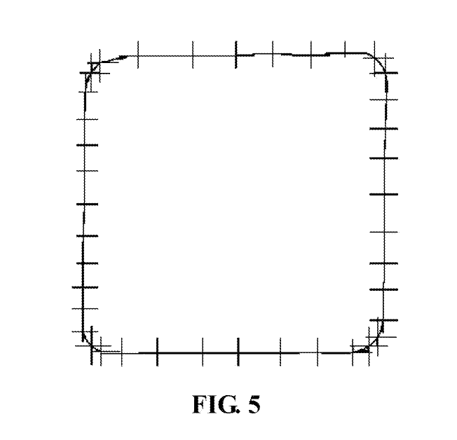

In block 307, a simulation module 17 simulates the measurement points to a geometrical element using a predetermined algorithm according to a predetermined type of element. The predetermined type of the element can be, but is not limited to, a line type, a circle type or a surface type. The geometrical element can be, but is not limited to, a line, a circle or a surface. If the predetermined type of the element is the line type, the line is simulated. If the predetermined type of the element is the circle type, the circle is simulated. If the predetermined type of the element is the surface type, the surface is simulated. The predetermined algorithm can be, but is not limited to, a triangulation algorithm, a least square method, a singular value decomposition (SVD) method, or a quaternion algorithm. As shown in FIG. 5, the line is simulated according to the measurement points shown of FIG. 4 using the predetermined algorithm.

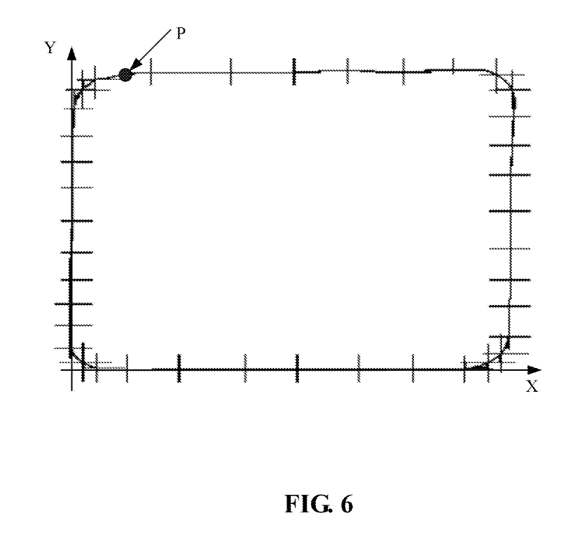

In block 308, a coordinate compensating module 18 establishes a coordinate system according to the geometrical element, determines coordinates of the measurement points in the coordinate system, and calculates a difference between the determined coordinates of each measurement point and reference coordinates of a reference point corresponding to each measurement point. As shown in FIG. 6, the coordinate system including an X-axis and a Y-axis is generated according to the geometrical element. The coordinate compensating module 18 compensates each reference coordinate of the reference points using the difference. That is, the coordinate compensating module 18 adjusts the CNC program according to the difference, so that the CNC machine 2 accurately processes the object using the CNC program.

In other blocks, after the image measurement of the object, the protection box 231 drives the motor 235 to close the cover of the protection box 231, and the light system 232 turns off the first light source and the second source.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A computing device comprising:
at least one processor; and
a storage device that stores one or more programs, which when executed by the at least one processor, causes the at least one processor to:
control a computerized numerical control (CNC) machine to move along a principle axis of the CNC machine;
control a charge coupled device (CCD) to capture images of an object located at a platform of the CNC machine;
obtain coordinates corresponding to each image during the movement of the CNC machine;
process the images to obtain a focus of a lens of the CNC machine, and obtain a first image corresponding to the focus of the lens;
control the CNC machine to move to the focus of the lens and control the CCD to capture a second image of the object;
obtain measurement points according to the second image;
simulate the measurement points to a geometrical element according to a predetermined type of an element using a predetermined algorithm;
establish a coordinate system according to the geometrical element;
determine coordinates of the measurement points in the coordinate system; and
calculate a difference between the determined coordinates of each measurement point and reference coordinates of a reference point corresponding to each measurement point.

2. The computing device of claim 1, wherein the focus of the lens of the CNC machine is obtained as following:
process the images of the object using a binary processing method to generate a pixel gray value of each image;
generate a line chart using the pixel gray value of each image, an abscissa of the line chart representing the pixel gray value of the image, and a vertical axis of the line chart representing a Z-axis value of the coordinates of the lens when the image is captured, the focus of the lens is a maximum Z-axis value of the coordinates of the lens among the line chart.

3. The computing device of claim 2, wherein the first image corresponding to the focus of the lens is an image which is captured by the lens located at the maximum Z-axis value of the coordinates of the lens among the line chart.

4. The computing device of claim 1, wherein measurement points are obtained according to the second image as following:
generate a contour of the object using a binary processing method; and
obtain interchange points using the contour of the object and predetermined measurement lines, the interchange points being the measurement points.

5. The computing device of claim 4, wherein the measurement lines are arrows on the object indicating a processing position of the object.

6. The computing device of claim 1, wherein the predetermined type of the element is selected from a group consisting of a line type, a circle type and a surface type.

7. The computing device of claim 1, wherein the geometrical element is selected from a group consisting of a line, a circle and a surface.

8. The computing device of claim 1, wherein the predetermined algorithm is selected from a group consisting of a triangulation algorithm, a least square method, a singular value decomposition (SVD) method, or a quaternion algorithm.

9. The computing device of claim 1, wherein the reference coordinates of the reference point is in a CNC program, the CNC program being an array program which consists of a plurality of the coordinates of reference points.

10. The computing device of claim 9, wherein the computing device adjusts the CNC program according to the difference, and processes the object using the adjusted CNC program.

11. A computer-based method for image measurement using a computing device, the method comprising:
controlling a computerized numerical control (CNC) machine to move along a principle axis of the CNC machine;
controlling a charge coupled device (CCD) to capture images of an object located at a platform of the CNC machine;
obtaining coordinates corresponding to each image during the movement of the CNC machine;
processing the images to obtain a focus of a lens of the CNC machine, and obtaining a first image corresponding to the focus of the lens;
controlling the CNC machine to move to the focus of the lens and controlling the CCD to capture a second image of the object;
obtaining measurement points according to the second image;
simulating the measurement points to a geometrical element according to a predetermined type of an element using a predetermined algorithm;
establishing a coordinate system according to the geometrical element;
determining coordinates of the measurement points in the coordinate system; and
calculating a difference between the determined coordinates of each measurement point and reference coordinates of a reference point corresponding to each measurement point.

12. The method of claim 11, wherein the focus of the lens of the CNC machine is obtained as following:
process the images of the object using a binary processing method to generate a pixel gray value of each image;
generate a line chart using the pixel gray value of each image, an abscissa of the line chart representing the pixel gray value of the image, and a vertical axis of the line chart representing a Z-axis value of the coordinates of the lens when the image is captured, the focus of the lens is a maximum Z-axis value of the coordinates of the lens among the line chart.

13. The method of claim 12, wherein the first image corresponding to the focus of the lens is an image which is captured by the lens located at the maximum Z-axis value of the coordinates of the lens among the line chart.

14. The method of claim 11, wherein measurement points are obtained according to the second image as following:
generate a contour of the object using a binary processing method; and
obtain interchange points using the contour of the object and predetermined measurement lines, the interchange points being the measurement points.

15. The method of claim 14, wherein the measurement lines are arrows on the object indicating a processing position of the object.

16. The method of claim 11, wherein the predetermined type of the element is selected from a group consisting of a line type, a circle type and a surface type.

17. The method of claim 11, wherein the geometrical element is selected from a group consisting of a line, a circle and a surface.

18. The method of claim 11, wherein the predetermined algorithm is selected from a group consisting of a triangulation algorithm, a least square method, a singular value decomposition (SVD) method, or a quaternion algorithm.

19. The method of claim 11, wherein the reference coordinates of the reference point is in a CNC program, the CNC program being an array program which consists of a plurality of the coordinates of reference points.

20. The method of claim 19, wherein the computing device adjusts the CNC program according to the difference, and processes the object using the adjusted CNC program.
